(19) United States
(12) Patent Application Publication
(10) Pub. No.: US 2016/0097642 A1
(43) Pub. Date: Apr. 7, 2016

(54) MEMS SENSOR MODULE, VIBRATION DRIVING MODULE, AND MEMS SENSOR

(71) Applicant: Murata Manufacturing Co., Ltd., Nagaokakyo-shi (JP)

(72) Inventors: Tsuyoshi Okami, Hamamatsu-shi (JP); Nobuaki TSUJI, Hamamatsu-shi (JP); Hidekazu ONO, Hamamatsu-shi (JP)

(21) Appl. No.: 14/970,844

(22) Filed: Dec. 16, 2015

Related U.S. Application Data
(63) Continuation of application No. PCT/JP2014/066040, filed on Jun. 17, 2014.

(30) Foreign Application Priority Data
Jun. 19, 2013 (JP) 2013-128966
Jun. 19, 2013 (JP) 2013-129004

(51) Int. Cl. G01C 19/5712; H02N 1/00

(52) U.S. Cl. CPC G01C 19/5712; H02N 1/008

(57) ABSTRACT

A MEMS sensor module of the present invention, in particular, a vibration driving module includes: a movable electrode supported such that the movable electrode is able to be vibrated, the movable electrode extending in a vibration direction; a fixed electrode provided substantially in parallel with the movable electrode and extending in the vibration direction; a plurality of projection portions provided side by side on a facing wall surface of the movable electrode in the vibration direction, the facing wall surface of the movable electrode facing the fixed electrode; and a plurality of projection portions provided on a facing wall surface of the fixed electrode, the facing wall surface of the fixed electrode facing the movable electrode, the plurality of projection portions of the fixed electrode facing the projection portions of the movable electrode.

The present application is a continuation of PCT Application PCT/JP2014/066040 filed Jun. 17, 2014 and claims a priority based on Japanese Patent Application No. 2013-128966 and Japanese Patent Application No. 2013-129004 filed in Japan on Jun. 19, 2013, the contents of which are incorporated by reference herein.

### TECHNICAL FIELD

The present invention relates to a MEMS sensor module, a vibration driving module, and a MEMS sensor.

### BACKGROUND ART

In recent years, devices having a fine mechanical element formed using a semiconductor manufacturing technology have been developed and have been implemented as an acceleration sensor or a gyro sensor which detects an angular velocity of a target object. Such devices are called “MEMS (Micro Electro Mechanical Systems)”

An example of such a system is a, the gyro sensor which includes: a vibration driving module supported on a substrate such that the vibration driving module can be vibrated in an X direction, the substrate extending in X-Y directions; a moving body connected to the vibration driving module; a capacitance change detecting module supported by the moving body such that the capacitance change detecting module is elastically displaceable in the Y direction, the capacitance change detecting module detecting an amount of displacement in the Y direction; and the like.

In such a gyro sensor, the moving body and an movable electrode of the capacitance change detecting module supported by the moving body are always moved reciprocatively in the X direction by the vibration driving module. As displacement of the movable electrode in the Y direction, the gyro sensor detects Coriolis force acting on the movable electrode when the gyro sensor is rotated about the axis of a Z direction perpendicular to the X-Y plane. The movable electrode of the capacitance change detecting module is displaced by not only the Coriolis force acting due to a change in the direction of the gyro sensor but also a change in velocity in the Y direction of the gyro sensor. Accordingly, a difference between displacements of movable electrodes of two capacitance change detecting modules is taken to cancel acceleration in the Y direction applied to the gyro sensor, thereby detecting only the change of the direction of the gyro sensor on the X-Y plane.

In the vibration driving module used in such a MEMS sensor, it is a known technique that the movable electrode and the fixed electrode are provided with protrusion portions protruding alternately in the vibration direction and comb-shaped electrodes of the movable electrode are arranged alternately between comb-shaped electrodes of the fixed electrode to obtain driving force, thereby increasing amplitude and driving force (for example, see Japanese Patent Laying-Open No. 2013-96952).

In a conventional vibration driving module, in order to attract the movable electrode to the fixed electrode side, air between the electrodes needs to be discharged from between the electrodes or needs to be compressed between the electrodes. Resistance of such air is a major factor of restricting the driving force and the amplitude in such a fine MEMS. If a vibration driving module with insufficient driving force and amplitude is used for a MEMS sensor, sufficient detection precision for angular velocity may not be attained.

Moreover, in the conventional vibration driving module that generates vibration using electrostatic force between the movable electrode and the fixed electrode, a positional relation between the fixed electrode and the movable electrode is changed when the movable electrode is moved. Hence, the conventional vibration driving module has such a problem that driving force is changed depending on the position of the movable electrode.

### SUMMARY OF INVENTION

### Technical Problem

The present invention has been made under the circumstances described above, and has an object to provide a high-performance MEMS sensor module, particularly, a vibration driving module having large driving force and amplitude and a MEMS sensor using such a vibration driving module.

Moreover, the present invention has an object to provide a MEMS sensor module having good stability, particularly, a vibration driving module allowing for a small change in driving force and a MEMS sensor using such a vibration driving module.

### Solution to Problem

In order to solve the above-described problem, a MEMS sensor module according to the present invention includes:

a movable electrode which translates back and forth along an axis of movement;

first and second stationary electrodes facing first and second portions of the movable electrode, respectively;

a plurality of first projections extending from the movable electrode toward the first stationary electrode;

a plurality of second projections extending from the movable electrode toward the second stationary electrode;

a plurality of third projections extending from the first stationary electrode toward the first portion of the movable electrode such that each of the third projections partially overlaps a respective one of the second projections; and

a plurality of fourth projections extending from the second stationary electrode toward the second portion of the movable electrode such that each of the fourth projections partially overlaps a respective one of the second projections;

the first and third plurality of projections, on the one hand, and the second and fourth plurality of projections, on the other, partially overlapping one another in opposite directions.

The MEMS sensor module may be a vibration driving module that generates vibration in the vibration direction in accordance with application of voltage between the movable electrode and the fixed electrode. Moreover, the projection portions of the fixed electrode may be shifted, symmetrically with respect to a center line of the vibration, in the vibration direction relative to the projection portions of the movable electrode facing the projection portions of the fixed electrode.

With this vibration driving module, the projection portions of the movable electrode and the projection portions of the fixed electrode are shifted (deviated) from one another in the vibration direction, whereby electrostatic force acting therebetween includes a component in the vibration direction. Accordingly, since the movable electrode is moved in the length direction of a square cross section orthogonal to the central axis thereof, this movement does not greatly change a distance between each of the projection portions of the movable electrode and each of the projection portions of the fixed electrode, whereby air between the movable electrode and the fixed electrode does not need to be pushed out from between the movable electrode and the fixed electrode. Therefore, in this vibration driving module, air resistance during the movement of the movable electrode is small, thereby attaining large driving force and amplitude.

In the vibration driving module described above, the facing surface of each of the projection portions of the movable electrode or the facing surface of each of the projection portions of the fixed electrode may be inclined relative to the vibration direction.

In this vibration driving module, the facing surface of each of the projection portions of the movable electrode or the facing surface of each of the projection portions of the fixed electrode is inclined relative to the vibration direction, so that an effective distance (electrostatic gap) between the facing surface of each of the projection portions of the movable electrode and the facing surface of each of the projection portions of the fixed electrode is changed when the movable electrode is moved in the vibration direction. Using this change in electrostatic gap, this vibration driving module can complement a change in attracting force component in the vibration direction caused by a deviation between the facing surface of each of the projection portions of the movable electrode and the facing surface of each of the projection portions of the fixed electrode in the vibration direction. Accordingly, the vibration driving module allows for a small change in driving force in response to displacement of the movable electrode.

### Advantageous Effects of Invention

As described above, with the vibration driving module, the air resistance of the movable electrode is small and the driving force and amplitude are large during operations. Accordingly, a MEMS sensor using this vibration driving module is highly precise.

Moreover, in the vibration driving module, a change in driving force in response to displacement of the movable electrode is small. Accordingly, a MEMS sensor using this vibration driving module is highly precise.

### BRIEF DESCRIPTION OF DRAWINGS

FIG. 1 is a schematic plan view showing a vibration driving module of a first embodiment of the present invention.

FIG. 2 is a cross sectional view of the vibration driving module of FIG. 1 along an A-A line.

FIG. 3 is a schematic plan view showing a gyro sensor using the vibration driving module of the first embodiment of the present invention.

FIG. 4 is a schematic plan view showing a vibration driving module of a second embodiment of the present invention.

FIG. 5 is a cross sectional view of the vibration driving module of FIG. 4 along an A-A line.

FIG. 6 is an enlarged schematic plan view showing a positional relation between a projection portion of a movable electrode and a projection portion of a fixed electrode at a vibration center of the vibration driving module of FIG. 4.

FIG. 7 is an enlarged schematic plan view showing a positional relation between the projection portion of the displaced movable electrode and the projection portion of the fixed electrode in the vibration driving module of FIG. 4.

FIG. 8 is a graph showing a relation between an amount of displacement of a movable electrode and driving force in a vibration driving module of Example 2.

FIG. 9 is a schematic plan view showing a gyro sensor using the vibration driving module of the second embodiment of the present invention.

### DESCRIPTION OF EMBODIMENTS

### First Embodiment

With reference to figures, the following describes a vibration driving module of a first embodiment of the present invention in detail.

[Vibration Driving Module]

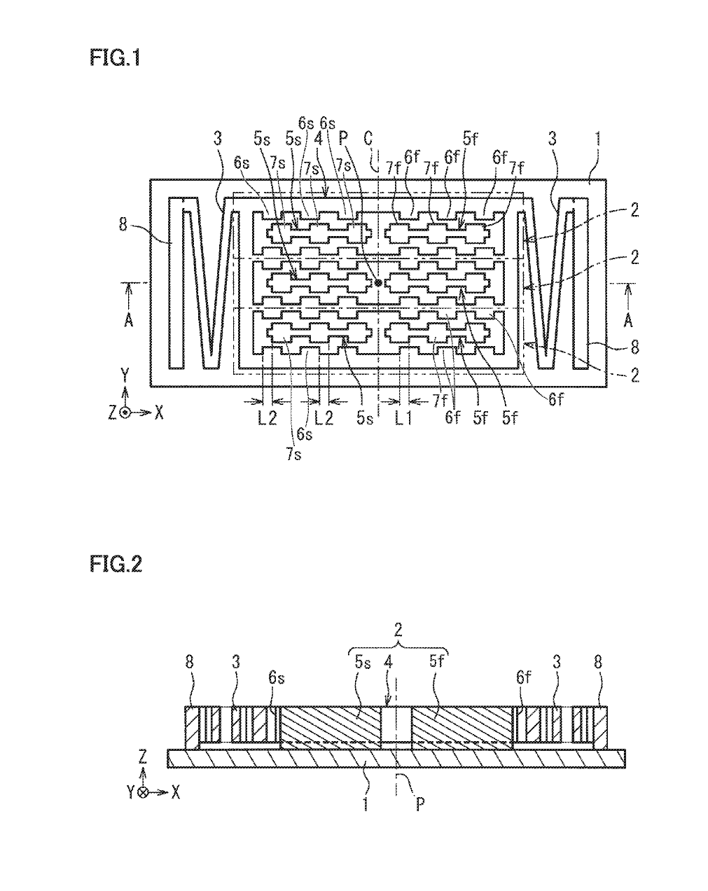

A vibration driving module of FIG. 1 and FIG. 2 is formed on a substrate 1 extending in X-Y directions, and includes: three vibration driving units 2 integrally formed and arranged side by side in the Y direction; and two elastic bodies 3 connected to respective sides of vibration driving units 2 in the X direction (axis of movement).

<Substrate>

Substrate 1 serves as a base that supports vibration driving units 2 and elastic bodies 3, and is provided with an electric circuit for applying voltage to vibration driving units 2.

Substrate 1 can be made of a material such as silicon, for example.

<Vibration Driving Unit>

Each of vibration driving units 2 includes: a movable electrode 4 having a shape of rectangular frame with a height being in a Z axial direction orthogonal to the X-Y plane and with a longitudinal direction corresponding to the X direction; and a pair of first and second fixed electrodes 5f and 5s provided in movable electrode 4 symmetrically with respect to a vibration center line C in the longitudinal direction. This vibration driving unit 2 causes vibration of movable electrode 4 in the X direction by applying voltage between movable electrode 4 and each of fixed electrodes 5f and 5s.

(Movable Electrode)

Movable electrode 4 has three sets of longitudinal (long-side) inner walls facing one another. The longitudinal inner walls are provided with a plurality of projection portions 6f and 6s that are substantially in parallel with the Z axis and that are arranged in the vibration direction (X direction) symmetrically with respect to vibration center line C. Projection portions 6f face first fixed electrode 5f and projection portions 6s face second fixed electrode 5s. Movable electrode 4 is integrally formed with a space interposed between movable electrode 4 and substrate 1, and is supported by the pair of elastic bodies 3.

Thus, the projection portions of movable electrode 4 are formed symmetrically on the pair of longitudinal inner walls in the shape of rectangular frame. Therefore, when the fixed electrodes having surfaces both provided with projection portions are provided on inner sides of the inner walls of the movable electrode, the movable electrode can be vibrated as a result of the electrostatic force generated at both the surfaces of the fixed electrodes.

The lower limit of an average length of projection portions 6f and 6s of movable electrode 4 in the vibration direction is preferably 1 μm, and is more preferably 4 μm. If the average length of projection portions 6f and 6s of movable electrode 4 in the vibration direction is less than the lower limit value, a range of generating strong electrostatic force in the vibration direction is small, with the result that the driving force and amplitude may become insufficient. On the other hand, the upper limit of the average length of projection portions 6f and 6s of movable electrode 4 in the vibration direction is preferably 20 μm and is more preferably 15 μm. If the average length of projection portions 6f and 6s of movable electrode 4 in the vibration direction is more than value, area efficiency is decreased, with the result that the driving force of the vibration driving module may become insufficient and the vibration driving module may become unnecessarily large.

The lower limit of an interval (space) between projection portions 6f and 6s of movable electrode 4 in the vibration direction is preferably ½ of the average length of projection portions 6f and 6s in the vibration direction, and is more preferably ¾ of the average length of projection portions 6f and 6s in the vibration direction. If the interval between projection portions 6f and 6s of movable electrode 4 in the vibration direction is less than the lower limit value, adjacent projection portions 6f and 6s interfere with each other, with the result that the driving force and amplitude of the vibration driving module may become insufficient. On the other hand, the upper limit of the interval between projection portions 6f and 6s of movable electrode 4 in the vibration direction is preferably as twice as the average length of projection portions 6f and 6s in the vibration direction, and is more preferably 3/2 of the average length of projection portions 6f and 6s in the vibration direction. If the interval between projection portions 6f and 6s of movable electrode 4 in the vibration direction is more than the upper limit value, area efficiency is decreased, with the result that the driving force of the vibration driving module may become insufficient and the vibration driving module may become unnecessarily large.

The lower limit of an average protrusion length (length in the Y direction) of projection portions 6f and 6s of movable electrode 4 is preferably 1 μm and is more preferably 2 μm. If the average protrusion length of projection portions 6f and 6s of movable electrode 4 is less this the lower limit value, an electric field is formed between each of fixed electrodes 5f and 5s and each of recesses between projection portions 6f and 6s of movable electrode 4 to interfere with the electric field formed by projection portions 6f and 6s, with the result that the driving force and amplitude of the vibration driving module may become insufficient. On the other hand, the upper limit of the average protrusion length of projection portions 6f and 6s of movable electrode 4 is preferably 20 μm and is more preferably 10 μm. If the average protrusion length of projection portions 6f and 6s of movable electrode 4 is more than this upper limit value, the vibration driving module may become unnecessarily large in the Y direction.

Movable electrode 4 can be made of a material such as silicon, for example.

(Fixed Electrode)

First and second fixed electrodes 5f and 5s are fixedly formed on substrate 1. Moreover, fixed electrodes 5f and 5s have a plurality of projection portions 7f and 7s formed on their surfaces to respective face projection portions 6f and 6s of movable electrode 4. Each of the portions located between projection portions 7f and 7s is formed in the form of a thin plate spaced away from movable electrode 4. Projection portions 7f and 7s of fixed electrodes 5f and 5s protrude in the Y axis direction relative to the planes parallel to the longitudinal inner walls of movable electrode 4. Projection portions 7f and 7s are formed symmetrically with respect to vibration center line C, and are formed to be shifted in the vibration direction to the vibration center C side relative to projection portions 6f and 6s of movable electrode 4 by a certain amount.

The lower limit of the average length of projection portions 7f and 7s of fixed electrode 5f and 5s in the vibration direction is preferably 1 μm, and is more preferably 4 μm. If the average length of projection portions 7f and 7s of fixed electrodes 5f and 5s in the vibration direction is less than this lower limit value, a range of generating strong electrostatic force in the vibration direction is small, with the result that the driving force and amplitude may become insufficient. On the other hand, the upper limit of the average length of projection portions 7f and 7s of fixed electrodes 5f and 5s in the vibration direction is preferably 20 μm and is more preferably 10 μm. If the average length of projection portions 7f and 7s of fixed electrodes 5f and 5s in the vibration direction is more than this upper limit value, area efficiency is decreased, with the result that the driving force of the vibration driving module may become insufficient and the vibration driving module may become unnecessarily large.

As described above, each of the average lengths of the projection portions of the movable electrode and the projection portions of the fixed electrodes in the vibration direction is preferably not less than 1 μm and not more than 20 μm. With each of such average lengths of the projection portions of the movable electrode and the projection portions of the fixed electrodes in the vibration direction, the projection portions can be provided in high density while avoiding interference with adjacent projection portions, with the result that the driving force of the vibration driving module can be increased and the vibration driving module can be small.

The lower limit of the interval (space) between projection portions 7f and 7s of fixed electrodes 5f and 5s in the vibration direction is preferably ½ of the average length of projection portions 7f and 7s in the vibration direction, and is more preferably ¾ of the average length of projection portions 7f and 7s in the vibration direction. If the interval between projection portions 7f and 7s of fixed electrodes 5f and 5s in the vibration direction is less than this lower limit value, adjacent projection portions 7f and 7s interfere with each other, with the result that the driving force and amplitude of the vibration driving module may become insufficient. On the other hand, the upper limit of the interval between projection portions 7f and 7s of fixed electrodes 5f and 5s in the vibration direction is preferably as twice as the average length of projection portions 7f and 7s in the vibration direction, and is more preferably 3/2 of the average length of projection portions 7f and 7s in the vibration direction. If the interval between projection portions 7f and 7s of fixed electrodes 5f and 5s in the vibration direction is more than this upper limit value, area efficiency is decreased, with the result that the driving force of the vibration driving module may become insufficient and the vibration driving module may become unnecessarily large.

The lower limit of the average protrusion length (length in the Y direction) of projection portions 7f and 7s of fixed electrodes 5f and 5s is preferably 1 μm and is more preferably 2 μm. If the average protrusion length of projection portions 7f and 7s of fixed electrodes 5f and 5s is less than this lower limit value, an electric field is formed between movable electrode 4 and each of recesses between projection portions 7f and 7s of fixed electrodes 5f and 5s to interfere with an electric field formed by projection portions 7f and 7s, with the result that the driving force and amplitude of the vibration driving module may become insufficient. On the other hand, the upper limit of the average protrusion length of projection portions 7f and 7s of fixed electrodes 5f and 5s is preferably 20 μm and is more preferably 10 μm. If the average protrusion length of projection portions 7f and 7s of fixed electrodes 5f and 5s is more than this upper limit value, the vibration driving module may become unnecessarily large in the Y direction.

The lower limit of an average overlapping length L1 of projection portions 6f and 6s of movable electrode 4 and projection portions 7f and 7s of fixed electrodes 5f and 5s in the vibration direction is preferably 1 μm and is more preferably 2 μm. If average overlapping length L1 of projection portions 6f and 6s of movable electrode 4 and projection portions 7f and 7s of fixed electrodes 5f and 5s in the vibration direction is less than this lower limit value, projection portions 6f and 6s of movable electrode 4 and projection portions 7f and 7s of fixed electrodes 5f and 5s are spaced away from each other during vibration of movable electrode 4, with the result that the driving force and amplitude of the vibration driving module may become insufficient. On the other hand, the upper limit of average overlapping length L1 of projection portions 6f and 6s of movable electrode 4 and projection portions 7f and 7s of fixed electrodes 5f and 5s in the vibration direction is preferably 10 μm and is more preferably 8 μm. If average overlapping length L1 of projection portions 6f and 6s of movable electrode 4 and projection portions 7f and 7s of fixed electrodes 5f and 5s in the vibration direction is more than this upper limit value, the vibration driving module may become unnecessarily large in the vibration direction.

As described above, the average overlapping length of the projection portions of the movable electrode and the projection portions of the fixed electrodes in the vibration direction is preferably not less than 1 μm and not more than 10 μm. If the average overlapping length of the projection portions of the movable electrode and the projection portions of the fixed electrodes in the vibration direction is less than this lower limit value, the movable electrode is spaced too far away from the fixed electrodes when the movable electrode is moved in the direction in which it is spaced away from the fixed electrodes, with the result that sufficient electrostatic force cannot be exhibited and the driving force may become insufficient. On the other hand, if the average overlapping length of the projection portions of the movable electrode and the projection portions of the fixed electrodes in the vibration direction is more than this upper limit value, a component of the electric field between the electrodes becomes relatively small in the vibration direction, with the result that driving force may become insufficient.

The lower limit of an average non-overlapping length L2 of projection portions 6f and 6s of movable electrode 4 and projection portions 7f and 7s of fixed electrodes 5f and 5s in the vibration direction is preferably 1 μm and is more preferably 2 μm. If average non-overlapping length L2 of projection portions 6f and 6s of movable electrode 4 and projection portions 7f and 7s of fixed electrodes 5f and 5s in the vibration direction is less than this lower limit value, a component of the electrostatic force in the vibration direction becomes small between each of projection portions 6f and 6s of movable electrode 4 and each of projection portions 7f and 7s of fixed electrodes 5f and 5s, with the result that the driving force and amplitude of the vibration driving module may become insufficient. On the other hand, the upper limit of average non-overlapping length L2 of projection portions 6f and 6s of movable electrode 4 and projection portions 7f and 7s of fixed electrodes 5f and 5s in the vibration direction is preferably 10 μm and is more preferably 8 μm. If average non-overlapping length L2 of projection portions 6f and 6s of movable electrode 4 and projection portions 7f and 7s of fixed electrodes 5f and 5s in the vibration direction is more than this upper limit value, a distance between each of projection portions 6f and 6s of movable electrode 4 and each of projection portions 7f and 7s of fixed electrodes 5f and 5s becomes substantially large, with the result that sufficient electrostatic force cannot be exhibited to presumably lead to insufficient driving force of the vibration driving module and the vibration driving module may become unnecessarily large in the vibration direction.

It should be noted that the average non-overlapping length of the projection portions of the movable electrode and the projection portions of the fixed electrodes in the vibration direction is determined as an average value of the lengths of the non-overlapping portions of all the projection portions of the movable electrode and the lengths of the non-overlapping portions of all the projection portions of the fixed electrodes.

As described above, the average overlapping length of the projection portions of the movable electrode and the projection portions of the fixed electrodes in the vibration direction is preferably not less than 1 μm and not more than 10 μm. If the average non-overlapping length of the projection portions of the movable electrode and the projection portions of the fixed electrodes in the vibration direction is less than this lower limit value, a component of the electric field between the electrodes becomes relatively small in the vibration direction, with the result that driving force may become insufficient. On the other hand, if the average non-overlapping length of the projection portions of the movable electrode and the projection portions of the fixed electrodes in the vibration direction is more than this upper limit value, the distance between the electrodes becomes substantially large, with the result that sufficient electrostatic force cannot be exhibited to presumably lead to insufficient driving force.

The lower limit of an average distance in a facing direction (Y direction) between each of projection portions 6f and 6s of movable electrode 4 and each of projection portions 7f and 7s of fixed electrodes 5f and 5s is preferably 0.1 μm and is more preferably 1 μm. If the average distance in the facing direction between each of projection portions 6f and 6s of movable electrode 4 and each of projection portions 7f and 7s of fixed electrodes 5f and 5s is less than this lower limit value, the shearing resistance of air resulting from vibration of movable electrode 4 becomes large due to viscosity of the air, with the result that the driving force and amplitude of the vibration driving module may become insufficient. On the other hand, the upper limit of the average distance in the facing direction between each of projection portions 6f and 6s of movable electrode 4 and each of projection portions 7f and 7s of fixed electrodes 5f and 5s is preferably 10 μm and is more preferably 5 μm. If the average distance in the facing direction between each of projection portions 6f and 6s of movable electrode 4 and each of projection portions 7f and 7s of fixed electrodes 5f and 5s is more than this upper limit value, the electrostatic force becomes weak between each of projection portions 6f and 6s of movable electrode 4 and each of projection portions 7f and 7s of fixed electrodes 5, with the result that the driving force and amplitude of the vibration driving module may become insufficient.

Fixed electrodes 5f and 5s can be made of a material such as silicon, for example.

<Elastic Body>

Each of elastic bodies 3 is formed in a substantially V-like shape when viewed in the X-Y plane, and has one end connected to movable electrode 4 of vibration driving unit 2 and the other end fixed to a fixed wall 8 fixedly provided at substrate 1. Elastic body 3 is supported by fixed wall 8 with a space interposed between elastic body 3 and substrate 1. Accordingly, elastic body 3 supports movable electrode 4 such that it can be vibrated in the X direction within an elastic deformation range thereof.

Elastic body 3 can be also made of a material such as silicon, for example.

When voltage is applied between movable electrode 4 and each of first and second fixed electrodes 5f and 5s, an electrostatic force is generated between movable electrode 4 and each of first and second fixed electrodes 5f and 5s. This electrostatic force is concentrated between each of projection portions 7f and 7s of fixed electrodes 5f and 5s and each of projection portions 6f and 6s of movable electrode 4.

Movable electrode 4 is vibrates in the X direction in the following manner. First, a first driving voltage is applied between first fixed electrode 5f and movable electrode 4, thereby generating attracting force by static electricity between each of projection portions 7f of fixed electrode 5f and each of projection portions 6f of movable electrode 4, which face each other. Therefore, fixed electrode 4 is moved leftward (negative X direction) in FIG. 1. Next, the application of the first driving voltage to first fixed electrode 5f is stopped, and then second driving voltage is applied between second fixed electrode 5s and movable electrode 4. Accordingly, the attracting force between each of projection portions 7f and each of projection portions 6f facing each other becomes weak, with the result that movable electrode 4 is moved rightward in FIG. 1 due to restoring force of elastic body 3. Furthermore, with the second driving voltage, attracting force is generated by static electricity between each of projection portions 7s of fixed electrode 5s and each of projection portions 6s of movable electrode 4, which face each other. Therefore, fixed electrode 4 is further moved rightward (positive X direction) in FIG. 1. Next, the application of the second driving voltage to second fixed electrode 5s is stopped, and then the first driving voltage is applied again between first fixed electrode 5f and movable electrode 4, thereby moving the movable electrode leftward (negative X direction) in FIG. 1 again. Movable electrode 4 can be vibrated in the X direction by repeating the application of the first and second driving voltages at a predetermined cycle.

<Method of Producing Vibration Driving Unit>

Each of vibration driving units 2 can be produced by a production method including the steps of: providing two silicon substrates on each other with a sacrifice layer interposed there between; forming planar shapes of movable electrode 4, elastic bodies 3, and fixed electrodes 5f and 5s by etching one of the silicon layers; and separating movable electrode 4 and elastic bodies 3 from the other of the silicon layers by removing the sacrifice layer through etching.

<Advantage>

In vibration driving unit 2 included in the vibration driving module, movable electrode 4 extends in the vibration direction, so that it is not necessary to discharge or compress the air between movable electrode 4 and each of fixed electrodes 5f and 5s. Accordingly, movable electrode 4 does not have large air resistance during vibration, whereby this vibration driving module provides large driving force and amplitude as well as excellent energy efficiency.

### Modification of First Embodiment

The vibration driving module is not limited to the first embodiment described above. In the first embodiment, the vibration driving module is configured to include the three vibration driving units; however, the number and arrangement of vibration driving unit(s) can be changed appropriately, and one vibration driving unit may be provided. Moreover, in the first embodiment, each of the projection portions of the fixed electrodes is shifted to the vibration center line C side relative to each of the projection portions of the movable electrode, but may be shifted to the opposite side (outwardly in the vibration direction). In this case, the relation between each of the fixed electrodes fed with voltage and the direction of movement of the movable electrode becomes opposite to that in the first embodiment.

[Gyro Sensor]

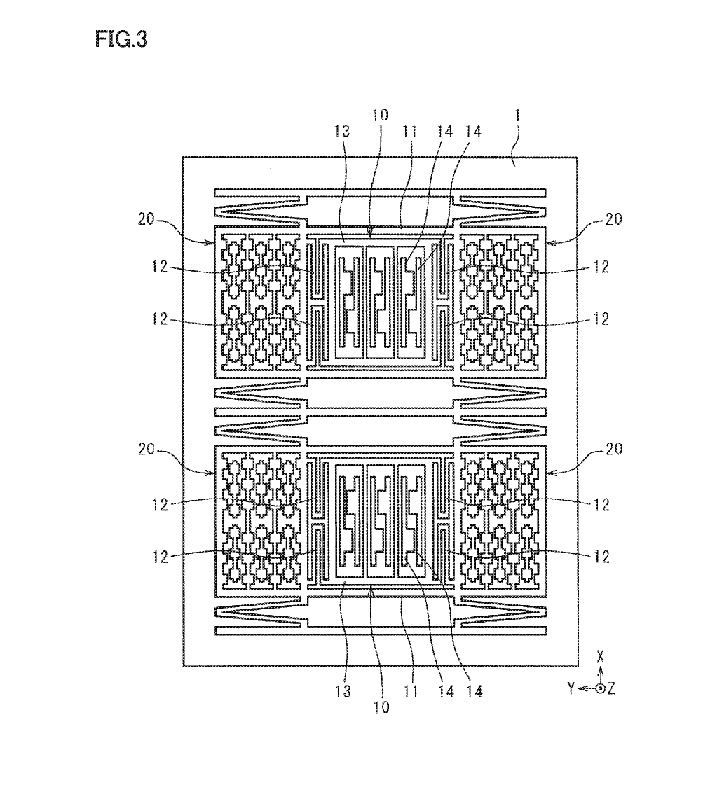

Next, with reference to FIG. 3, the following describes an embodiment of a gyro sensor (MEMS sensor), which uses the first vibration driving module described above.

The gyro sensor of FIG. 3 includes: substrate 1 extending in the X-Y directions; two capacitance change detecting modules 10 formed side by side; and two pairs (four in total) of vibration driving modules 20 of the first embodiment, vibration driving modules 20 being provided on the both sides of each capacitance change detecting module 10 in the Y direction.

<Vibration Driving Module>

Since the configuration of each of vibration driving modules 20 is the same as that of the vibration driving module of FIG. 1, no repeated description will be provided. Each pair of vibration driving modules 20 support a moving body 11, which is formed in the form of a quadrangular frame to surround capacitance change detecting module 10, and generate vibration in synchronism, thereby vibrating moving body 11 in the X direction.

<Capacitance Change Detecting Module>

Each of capacitance change detecting modules 10 is attached to moving body 11 by four driving springs 12 such that it is movable in the Y direction. Capacitance change detecting module 10 includes: a movable detection electrode 13 having a shape of three continuous frames integrally formed and arranged side by side in the Y direction; and fixed detection electrodes 14 fixedly formed on substrate 1.

In this gyro sensor, movable detection electrode 13 of capacitance change detecting module 10 is always reciprocally moved in the X direction by vibration driving modules 20. In this state, Coriolis force acting on movable detection electrode 13 when the gyro sensor is rotated around the axis of the Z direction perpendicular to the X-Y plane is detected as a change of capacitance, caused by displacement of movable detection electrode 13 in the Y direction, between movable detection electrode 13 and each of fixed detection electrodes 14 and is converted into a change of direction of this gyro sensor.

Movable detection electrode 13 of capacitance change detecting module 10 is displaced in the Y direction by not only the Coriolis force resulting from the change of the direction of the gyro sensor but also inertia force resulting from a change of velocity of this gyro sensor in the Y direction. Hence, in this gyro sensor, a difference between displacements of movable detection electrodes 13 of two capacitance change detecting modules 10 is taken to cancel acceleration applied to this gyro sensor in the Y direction, thereby detecting only the Coriolis force generated by the rotation of this gyro sensor about the axis of the Z direction extending in the middle between two capacitance change detecting modules 10.

This gyro sensor can be produced by forming the components of vibration driving modules 20 and capacitance change detecting modules 10 on substrate 1 made of, for example, silicon by means of known semiconductor manufacturing technology such as photolithography, lamination of materials, etching, and the like.

<Advantage>

Since the gyro sensor includes vibration driving modules 20, movable electrode 4 does not have large air resistance during vibration, whereby the amplitude of movable detection electrode 13 in the X direction is large. Accordingly, the Coriolis force acting on movable detection electrode 13 becomes large, whereby the angular velocity can be detected with good precision.

Therefore, the MEMS sensor including the vibration driving module of the first embodiment is excellent in detection precision since the driving force and amplitude of this vibration driving module are sufficiently large.

### Modification of the Present Embodiment

The gyro sensor of the present invention is not limited to the above-described embodiment. In the above-described embodiment, the movable detection electrode is vibrated using two vibration driving units disposed to sandwich the movable detection electrode in the Y direction; however, the vibration driving modules can be disposed in any manner as long as the movable detection electrode is vibrated in the X direction.

Moreover, in the above-described gyro sensor, the structure of the capacitance change detecting module is not limited to the above-described embodiment. For example, the same structure as that of vibration driving module 20 of the first embodiment can be employed as the capacitance change detecting module. Namely, movable detection electrode 13 of the capacitance change detecting module may have the same shape as that of movable electrode 4 provided with the plurality of projection portions. Moreover, fixed detection electrode 14 of the capacitance change detecting module may have the same shape as that of each of first and second fixed electrodes 5f and 5s each including the plurality of projection portions. In this case, the plurality of projection portions of the fixed detection electrode and the projection portions of the movable detection electrode are provided to face each other; however, a positional relation therebetween is the same as the positional relation between each of projection portions 7f and 7s and each of projection portions 6f and 6s of vibration driving module 20.

Also when the capacitance change detecting module is thus structured, Coriolis forces acting on the movable detection electrodes of the two capacitance change detecting modules when the gyro sensor is rotated about the axis of the Z direction perpendicular to the X-Y plane are detected as change of capacitance, caused by displacements of the movable detection electrodes in the Y direction, between the movable detection electrodes and the fixed detection electrodes, and can be converted into the change of direction of this gyro sensor as with the case described above.

### Example 1

The following describes the vibration driving module of the first embodiment of the present invention more in detail by way of an Example 1; however, the present invention is not limited to Example 1.

### Example 1

For Example 1 of the vibration driving module of the first embodiment configured as described above, air resistance was analyzed by simulation using a computer. In a model used in the simulation, each of the movable electrode and the fixed electrodes of Example 1 has a total of twenty projection portions protruding in the Y direction (ten projection portions for driving at one side). Each of the projection portions of the movable electrode has a protrusion length of 5 μm in the Y direction and has a length of 5 μm in the X direction, and an interval between adjacent projection portions of the movable electrode in the X direction is 5 μm. On the other hand, each of the projection portions of the fixed electrodes has a protrusion length of 4 μm in the Y direction and has a length of 5 μm in the X direction, and an interval between adjacent projection portions of the fixed electrodes in the X direction is 5 μm. An overlapping length (average overlapping length) of the projection portions of the movable electrode and the projection portions of the fixed electrodes at the vibration center in the vibration direction is 2.5 μm, and a distance (gap) between the facing surface of the projection portion of the movable electrode and the facing surface of the projection portion of the fixed electrode is 1.5 μm.

### Comparative Example

Moreover, for comparison with Example 1, air resistance was analyzed by simulation using a computer with regard to a vibration driving module conventionally configured to employ comb-shaped fixed and movable electrodes as shown in FIG. 1 of Patent Document 1. In the model of the comparative example used in the simulation, the movable electrode has comb-shaped portions each protruding in the X direction toward 12 fixed electrodes at each of the surfaces of a plate-like main body extending in the Y-Z plane (24 fixed electrodes in total for both the surfaces). Each of the fixed electrodes has 13 comb-shaped portions protruding in the X direction toward the movable electrode from the plate-like main body extending in the Y-Z plane. Each of the comb-shaped portions of the movable electrode has a width of 2 μm in the Y direction and has a length of 9 μm in the vibration direction (X direction). Each of the comb-shaped portions of the fixed electrode has a width of 3 μm in the Y direction and has a length of 9 μm in the X direction. A distance (gap) between the facing surface of each of the comb-shaped portions of the movable electrode and the facing surface of each of the comb-shaped portions of the fixed electrode is 1.5 μm. At the center in the vibration direction, a distance between the tip of each comb-shaped portion and the main body of the movable electrode or the fixed electrode is 5 μm.

(Result of Simulation)

By using the models of Example 1 and the comparative example, the value of air resistance acting on each of the movable electrodes when the movable electrode was moved by 1.3 μm in the X direction was determined by the simulations. As a result, the air resistance of the comparative example was 1.8×10⁻⁷ Ns/m, whereas the air resistance of Example 1 was 8.3×10⁻⁹ Ns/m. That is, the air resistance of the vibration driving module of the invention of the present application is about 1/21 of the air resistance of the conventional vibration driving module, and is very small resistance. Hence, when driving with certain electrostatic energy, the vibration driving module can generate effective driving force (value obtained by subtracting the air resistance from the electrostatic force) larger than that of the conventional configuration, thereby attaining a large amplitude.

### Second Embodiment

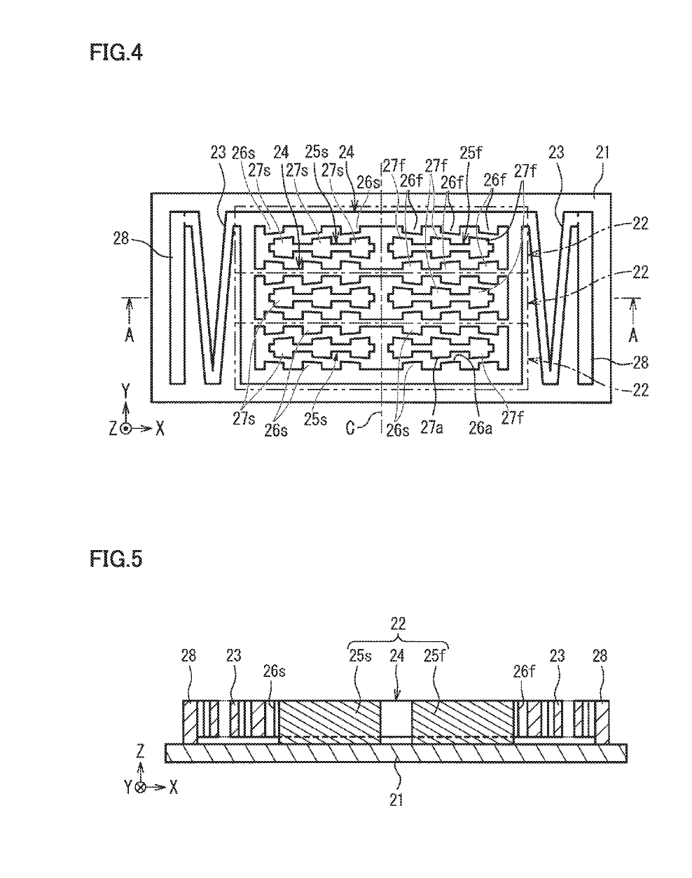

Next, with reference to FIG. 4 to FIG. 8, the following describes a vibration driving module according to a second embodiment of the present invention in detail.

[Vibration Driving Module]

A vibration driving module of FIG. 4 and FIG. 5 is formed on a substrate 21 extending in the X-Y directions. This vibration driving module includes: three vibration driving units 22 integrally formed and arranged side by side in the Y direction; and two elastic bodies 23 connected to both sides of each of vibration driving units 22 in the X direction.

<Substrate>

Substrate 21 serves as a base that supports vibration driving units 22 and elastic bodies 23, and is provided with an electric circuit for applying voltage to vibration driving units 22.

Substrate 21 can be made of a material such as silicon, for example.

<Vibration Driving Unit>

Each of vibration driving units 22 includes: a pair of movable electrodes 24 extending in the X direction, facing each other in the Y direction, and having a plate-like shape; and a pair of first and second fixed electrodes 25f and 25s that are bilaterally symmetrically provided between movable electrodes 24 with respect to vibration center line C in the X direction, that extend in the X direction, and that each have a plate-like shape. Movable electrodes 24 of adjacent vibration driving units 22 are formed integrally in the form of a plate. Furthermore, the respective ends of movable electrodes 24 of three vibration driving units 22 are connected to one another by connection portions extending in the Y direction. Movable electrodes 24 thus integrally connected to one another are supported by elastic bodies 23 with a space interposed between each of movable electrodes 24 and substrate 21, and can be vibrated in the X direction within a range of elastic deformation of elastic body 23. Vibration driving unit 22 thus configured applies voltage between movable electrode 24 and each of fixed electrodes 25f and 25s to cause vibration of movable electrode 24 in the X direction.

(Movable Electrode)

Each of movable electrodes 24 have a plurality of projection portions 26f and 26s provided at surfaces facing fixed electrodes 25f and 25s so as to protrude in the Y direction orthogonal to the vibration direction. These projection portions 26f and 26s are formed on inner walls of movable electrode 24 having a shape of quadrangular frame and are arranged side by side in the X direction. Projection portions 26f and 26s are provided bilaterally symmetrically with respect to center line C such that three projection portions 26f and 26s are provided to face the inner wall of each of first and second fixed electrode 25f and 25s.

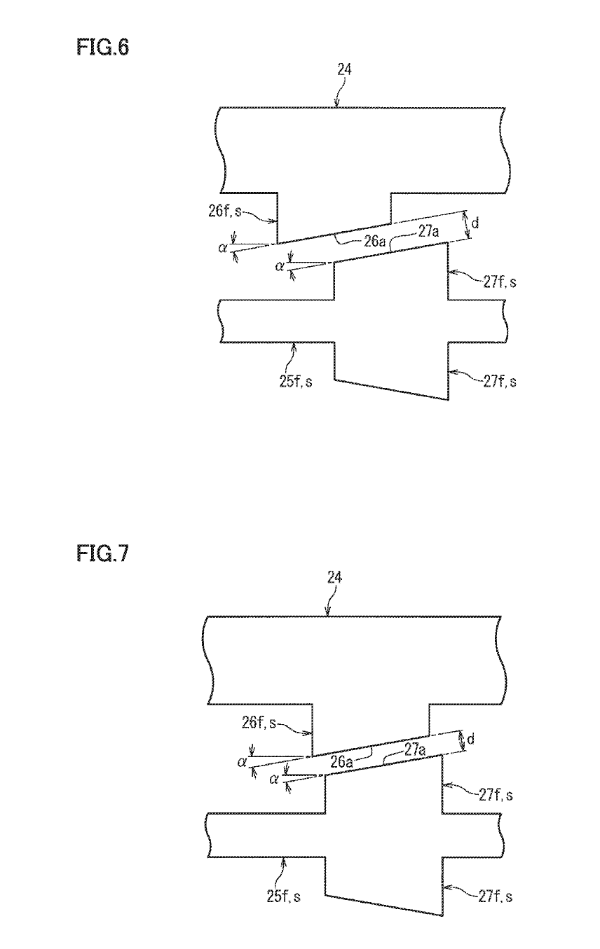

As shown in FIG. 6, in facing surface 26a of each of projection portions 26f and 26s facing fixed electrodes 25f and 25s, a protrusion length of movable electrode 24 at the side edge close to vibration center line C in the Y direction is smaller than a protrusion length thereof at the other side edge in the Y direction. Namely, facing surface 26a is inclined to have an angle α relative to the vibration direction (X direction). Accordingly, the normal line of facing surface 26a of each of projection portions 26f and 26s of movable electrode 24 is inclined toward each of the center sides of projection portions 27f and 27s of fixed electrodes 25f and 25s facing projection portions 26f and 26s of movable electrode 24.

As described above, in the second embodiment, the facing surface of each of the projection portions of movable electrode 24 and the facing surface of each of the projection portions of fixed electrodes 25f and 25s are inclined relative to the vibration direction. With this configuration, a change in driving force of the vibration driving module in response to displacement of movable electrode 24 can be made smaller.

The lower limit of inclination angle α of facing surface 26a of each of projection portions 26f and 26s of movable electrode 24 relative to the vibration direction is preferably 0.1° and is more preferably 0.5°. When inclination angle α of facing surface 26a of each of projection portions 26f and 26s of movable electrode 24 relative to the vibration direction is less than this lower limit value, a function of regulating the electrostatic force becomes insufficient, with the result that a change in driving force due to displacement of movable electrode 24 may not be able to be sufficiently suppressed. The upper limit of inclination angle α of facing surface 26a of each of projection portions 26f and 26s of movable electrode 24 relative to the vibration direction is preferably 15°, and is more preferably 10°. If inclination angle α of facing surface 26a of each of projection portions 26f and 26s of movable electrode 24 relative to the vibration direction is more than this upper limit value, a change in electrostatic gap between fixed electrodes 25f and 25s becomes too large, with the result that a change in driving force due to displacement of movable electrode 24 may become large. On the other hand, if inclination angle α is more than the upper limit value, projection portions 26f and 26s interfere with fixed electrodes 25f and 25s, with the result that the movable range of movable electrode 24 may be restricted.

As described above, the inclination angle of the facing surface of each of the projection portions of the movable electrode or the facing surface of each of the projection portions of the fixed electrodes relative to the vibration direction is preferably not less than 0.1° and not more than 15°. By setting the inclination angle to fall within this range, a change in driving force of the vibration driving module in response to displacement of the movable electrode can be sufficiently small.

The lower limit of the average length of projection portions 26f and 26s of movable electrode 24 in the vibration direction (X direction) is preferably 1 μm, and is more preferably 4 μm. If the average length of projection portions 26f and 26s of movable electrode 24 in the vibration direction is less than this lower limit value, a range of generating strong electrostatic force in the vibration direction is small, with the result that the driving force and amplitude may become insufficient. On the other hand, the upper limit of the average length of projection portions 26f and 26s of movable electrode 24 in the vibration direction is preferably 20 μm and is more preferably 15 μm. If the average length of projection portions 26f and 26s of movable electrode 24 in the vibration direction is more than this upper limit value, area efficiency is decreased, with the result that the driving force of the vibration driving module may become insufficient and the vibration driving module may become unnecessarily large.

The lower limit of an interval (space) between projection portions 26f and 26s of movable electrode 24 in the vibration direction is preferably ½ of the average length of projection portions 26f and 26s in the vibration direction, and is more preferably ¾ of the average length of projection portions 26f and 26s in the vibration direction. If the interval between projection portions 26f and 26s of movable electrode 24 in the vibration direction is less than this lower limit value, adjacent projection portions 26f and 26s interfere with each other, with the result that the driving force and amplitude of the vibration driving module may become insufficient. On the other hand, the upper limit of the interval between projection portions 26f and 26s of movable electrode 24 in the vibration direction is preferably as twice as the average length of projection portions 26f and 26s in the vibration direction, and is more preferably 3/2 of the average length of projection portions 26f and 26s in the vibration direction. If the interval between projection portions 26f and 26s of movable electrode 24 in the vibration direction is more than this upper limit value, area efficiency is decreased, with the result that the driving force of the vibration driving module may become insufficient and the vibration driving module may become unnecessarily large.

The lower limit of the average protrusion length (length in the Y direction) of projection portions 26f and 26s of movable electrode 24 is preferably 1 μm and is more preferably 2 μm. If the average protrusion length of projection portions 26f and 26s of movable electrode 24 is less than this lower limit value, an electric field is formed between each of fixed electrodes 25f and 25s and each of recesses between projection portions 26f and 26s of movable electrode 24 to interfere with the electric field formed by projection portions 26f and 26s, with the result that the driving force and amplitude of the vibration driving module may become insufficient. On the other hand, the upper limit of the average protrusion height of projection portions 26f and 26s of movable electrode 24 is preferably 20 μm and is more preferably 10 μm. If the average protrusion height of projection portions 26f and 26s of movable electrode 24 is more than this upper limit value, the vibration driving module may become unnecessarily large in the Y direction.

Movable electrode 24 can be made of a material such as silicon, for example.

(Fixed Electrode)

First and second fixed electrodes 25f and 25s are fixedly formed on substrate 21. Moreover, each of fixed electrodes 25f and 25s has three projection portions 27f and 27s provided at each of its surfaces facing movable electrode 24 (six in total for both the surfaces) such that the three projection portions 27f and 27s face projection portions 26f and 26s of movable electrode 24. These projection portions 27f and 27s are formed on the side walls of first and second fixed electrodes 25f and 25s, the side walls standing in the Z axis direction and extending in the Y axis direction. Projection portions 27f and 27s of fixed electrodes 25f and 25s are formed symmetrically with respect to vibration center line C of movable electrode 24 so as to be shifted to the vibration center line C side by a certain amount relative to projection portions 26f and 26s of movable electrode 24.

As such, the projection portions of the fixed electrodes are shifted in the vibration direction relative to the projection portions of the movable electrode facing the projection portions of the fixed electrodes, and the normal line of the inclined facing surface of each of the projection portions of the movable electrode or the inclined facing surface of each of the projection portions of the fixed electrodes is inclined toward the center side of each of the projection portions of the fixed electrodes or the projection portions of the movable electrode. With such a configuration, as the distance between the center of the projection portion of the fixed electrode and the center of the projection portion of the movable electrode becomes smaller to result in a larger inclination of a direction of exertion of electrostatic force relative to the vibration direction, a gap between the facing surfaces becomes small and electrostatic force becomes large. Accordingly, a change in component of electrostatic force in the vibration direction can be suppressed sufficiently.

Moreover, as shown in FIG. 6, in facing surface 27a of each of projection portions 27f and 27s facing projection portions 26f and 26s of movable electrode 24, a protrusion length of the movable electrode 24 at the side edge which is close to the vibration center line C in the Y direction is longer than the protrusion length thereof at the other side edge in the Y direction, and is inclined to have an angle α relative to the vibration direction (X direction). That is, facing surface 26a of each of projection portions 26f and 26s of movable electrode 24 and facing surface 27a of each of projection portions 27f and 27s of fixed electrodes 25f and 25s are parallel to each other. Accordingly, the normal line of facing surface 26a of each of projection portions 26f and 26s of movable electrode 24 is inclined toward the center side of each of projection portions 27f and 27s of fixed electrodes 25f and 25s facing projection portions 26f and 26s of movable electrode 24.

As described above, facing surface 26a of each of the projection portions of the movable electrode and facing surface 27a of each of the projection portions of the fixed electrode may be parallel to each other. With such a configuration, electric charges are suppressed from being uneven in the facing surfaces of the projection portions, thereby generating electrostatic force efficiently. It should be noted that the expression “substantially parallel” is intended to include an inclination of not more than ±0.1°.

The lower limit of inclination angle α of facing surface 27a of each of projection portions 27f and 27s of fixed electrodes 25f and 25s relative to the vibration direction is preferably 0.1° and is more preferably 0.5°. If inclination angle α of facing surface 27a of each of projection portions 27f and 27s of fixed electrodes 25f and 25s relative to the vibration direction is less than this lower limit value, a function of regulating the electrostatic force becomes insufficient, with the result that a change in driving force due to displacement of movable electrode 24 may not be able to be sufficiently suppressed. The upper limit of inclination angle α of facing surface 27a of each of projection portions 27f and 27s of fixed electrodes 25f and 25s relative to the vibration direction is preferably 15° and is more preferably 10°. If inclination angle α of facing surface 27a of each of projection portions 27f and 27s of fixed electrodes 25f and 25s relative to the vibration direction is more than this upper limit value, a change in gap between facing surface 27a and facing surface 26a of projection portions 26f and 26s of movable electrode 24 becomes too large, with the result that a change in driving force due to displacement of movable electrode 24 may become larger. If inclination angle α is more than this upper limit value, projection portions 27f and 27s interfere with each of projection portions 26f and 26s of movable electrode 24, with the result that the movable range of movable electrode 24 may be restricted.

The lower limit of the average length of projection portions 27f and 27s of fixed electrodes 25f and 25s in the vibration direction is preferably 1 μm, and is more preferably 4 μm. If the average length of projection portions 27f and 27s of fixed electrodes 25f and 25s in the vibration direction is less than this lower limit value, a range of generating strong electrostatic force in the vibration direction is small, with the result that the driving force and amplitude may become insufficient. On the other hand, the upper limit of the average length of projection portions 27f and 27s of fixed electrodes 25f and 25s in the vibration direction is preferably 20 μm and is more preferably 10 μm. If the average length of projection portions 27f and 27s of fixed electrodes 25f and 25s in the vibration direction is more than this upper limit value, area efficiency is decreased, with the result that the driving force of the vibration driving module may become insufficient and the vibration driving module may become unnecessarily large.

The lower limit of an interval (space) between projection portions 27f and 27s of fixed electrodes 25f and 25s in the vibration direction is preferably ½ of the average length of projection portions 27f and 27s in the vibration direction, and is more preferably ¾ of the average length of projection portions 27f and 27s in the vibration direction. If the interval between projection portions 27f and 27s of fixed electrodes 25f and 25s in the vibration direction is less than this lower limit value, adjacent projection portions 27f and 27s interfere with each other, with the result that the driving force and amplitude of the vibration driving module may become insufficient. On the other hand, the upper limit of the interval between projection portions 27f and 27s of fixed electrodes 25f and 25s in the vibration direction is preferably as twice as the average length of projection portions 27f and 27s in the vibration direction, and is more preferably 3/2 of the average length of projection portions 27f and 27s in the vibration direction. If the interval between projection portions 27f and 27s of fixed electrodes 25f and 25s in the vibration direction is more than this upper limit value, area efficiency is decreased, with the result that the driving force of the vibration driving module may become insufficient and the vibration driving module may become unnecessarily large.

The lower limit of the average protrusion length (length in the Y direction) of projection portions 27f and 27s of fixed electrodes 25f and 25s is preferably 1 μm and is more preferably 2 μm. If the average protrusion length of projection portions 27f and 27s of fixed electrodes 25f and 25s is less than this lower limit value, an electric field is formed between movable electrode 24 and each of recesses between projection portions 27f and 27s of fixed electrodes 25f and 25s to interfere with the electric field formed by projection portions 27f and 27s, with the result that the driving force and amplitude of the vibration driving module may become insufficient. On the other hand, the upper limit of the average protrusion length of projection portions 27f and 27s of fixed electrodes 25f and 25s is preferably 20 μm and is more preferably 10 μm. If the average protrusion height of projection portions 27f and 27s of fixed electrodes 25f and 25s is more than this upper limit value, the vibration driving module may become unnecessarily large in the Y direction.

The lower limit of an average overlapping length of projection portions 26f and 26s of movable electrode 24 and projection portions 27f and 27s of fixed electrodes 25f and 25s in the vibration direction is preferably 1 μm and is more preferably 2 μm. If the average overlapping length of projection portions 26f and 26s of movable electrode 24 and projection portions 27f and 27s of fixed electrodes 25f and 25s in the vibration direction is less than this lower limit value, projection portions 26f and 26s of movable electrode 24 are spaced away from projection portions 27f and 27s of fixed electrodes 25f and 25s during vibration of movable electrode 24, with the result that the driving force and amplitude of the vibration driving module may become insufficient. On the other hand, the upper limit of the average overlapping length of projection portions 26f and 26s of movable electrode 24 and projection portions 27f and 27s of fixed electrodes 25f and 25s in the vibration direction is preferably 10 μm and is more preferably 8 μm. If the average overlapping length of projection portions 26f and 26s of movable electrode 24 and projection portions 27f and 27s of fixed electrodes 25f and 25s in the vibration direction is more than this upper limit value, the vibration driving module may become unnecessarily large in the vibration direction.

The lower limit of an average non-overlapping length of projection portions 26f and 26s of movable electrode 24 and projection portions 27f and 27s of fixed electrodes 25f and 25s in the vibration direction is preferably 1 μm and is more preferably 2 μm. If the average non-overlapping length of projection portions 26f and 26s of movable electrode 24 and projection portions 27f and 27s of fixed electrodes 25f and 25s in the vibration direction is less than this lower limit value, a component of the electrostatic force in the vibration direction becomes small between each of projection portions 26f and 26s of movable electrode 24 and each of projection portions 27f and 27s of fixed electrodes 25f and 25s, with the result that the driving force and amplitude of the vibration driving module may become insufficient. On the other hand, the upper limit of the average non-overlapping length of projection portions 26f and 26s of movable electrode 24 and projection portions 27f and 27s of fixed electrodes 25f and 25s in the vibration direction is preferably 10 μm and is more preferably 8 μm. If the average non-overlapping length of projection portions 26f and 26s of movable electrode 24 and projection portions 27f and 27s of fixed electrodes 25f and 25s in the vibration direction is more than this upper limit value, a distance between each of projection portions 26f and 26s of movable electrode 24 and each of projection portions 27f and 27s of fixed electrodes 25f and 25s becomes substantially large, with the result that sufficient electrostatic force cannot be exhibited to presumably lead to insufficient driving force of the vibration driving module and the vibration driving module may become unnecessarily large in the vibration direction.

The lower limit of an average distance between each of projection portions 26f and 26s of movable electrode 24 and each of projection portions 27f and 27s of fixed electrodes 25f and 25s in the facing direction (Y direction) is preferably 0.1 μm and is more preferably 1 μm. If the average distance between each of projection portions 26f and 26s of movable electrode 24 and each of projection portions 27f and 27s of fixed electrodes 25f and 25s in the facing direction is less than this lower limit value, the shearing resistance of air resulting from the vibration of movable electrode 24 becomes large due to viscosity of the air, with the result that the driving force and amplitude of the vibration driving module may become insufficient. On the other hand, the upper limit of the average distance between projection portions 26f and 26s of movable electrode 24 and projection portions 27f and 27s of fixed electrodes 25f and 25s in the facing direction is preferably 10 μm and is more preferably 5 μm. If the average distance between each of projection portions 26f and 26s of movable electrode 24 and each of projection portions 27f and 27s of fixed electrodes 25f and 25s in the facing direction is more than this upper limit value, electrostatic force becomes weak between each of projection portions 26f and 26s of movable electrode 24 and each of projection portions 27f and 27s of fixed electrodes 25f and 25s, with the result that the driving force and amplitude of the vibration driving module may become insufficient.

Fixed electrodes 25f and 25s can be made of a material such as silicon, for example.

<Elastic Body>

Each of elastic bodies 23 is formed in the form of a substantially V-like shape when viewed in the X-Y plane, and has one end connected to movable electrode 24 of vibration driving unit 2 and the other end fixed to a fixed wall 28 provided in an unmovable manner at substrate 21. Elastic body 23 is supported by fixed wall 28 with a space interposed between elastic body 23 and substrate 21. Accordingly, elastic body 23 supports movable electrode 24 such that it can be vibrated in the X direction within an elastic deformation range thereof.

Elastic body 23 can be made of a material such as silicon, for example.

A driving method for vibrating movable electrode 24 in the X direction is the same as that in the first embodiment.

<Method of Producing Vibration Driving Unit>

Each of vibration driving units 22 can be produced by a production method including the steps of: providing two silicon substrates on each other with a sacrifice layer interposed there between; forming planar shapes of movable electrode 24, elastic bodies 23, and fixed electrodes 25f and 25s by etching one of the silicon layers; and separating movable electrode 24 and elastic bodies 23 from the other of the silicon layers by removing the sacrifice layer through etching.

<Function>

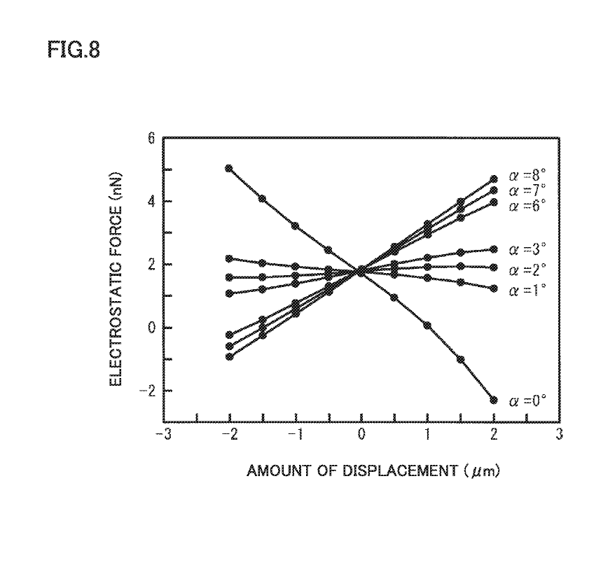

With reference to FIG. 6 and FIG. 7, the following describes a function of each of projection portions 26f and 26s of movable electrode 24 and projection portions 27f and 27s of fixed electrodes 25f and 25s in the vibration driving module.

As shown in FIG. 6, when voltage is applied between movable electrode 24 and each of fixed electrodes 25f and 25s in a state in which movable electrode 24 is located on vibration center C, i.e., in an arrangement in which no voltage has been applied yet between movable electrode 24 and each of fixed electrodes 25f and 25s, electrostatic force is generated to attract each of projection portions 26f and 26s of movable electrode 24 and each of projection portions 27f and 27s of fixed electrodes 25f and 25s to each other. The electrostatic force becomes smaller as a distance d is larger between facing surface 26a of each of projection portions 26f and 26s of movable electrode 24 and facing surface 27a of each of projection portions 27f and 27s of fixed electrodes 25f and 25s. Moreover, the direction of the electrostatic force acting between each of projection portions 26f and 26s of movable electrode 24 and each of projection portions 27f and 27s of fixed electrodes 25f and 25s is inclined depending on deviation (shift) of each of projection portions 26f and 26s of movable electrode 24 and projection portions 27f and 27s of fixed electrodes 25f and 25s in the vibration direction. A ratio of a component of the electrostatic force in the vibration direction (X direction) increases as the overlapping length of projection portions 26f and 26s of movable electrode 24 and projection portions 27f and 27s of fixed electrodes 25f and 25s in the vibration direction decreases (the non-overlapping length is longer).

As shown in FIG. 7, when such electrostatic force causes movable electrode 24 to move in the X direction toward fixed electrodes 25f and 25s fed with voltage, the overlapping length of projection portions 26f and 26s of movable electrode 24 and projection portions 27f and 27s of fixed electrodes 25f and 25s in the vibration direction is increased (the non-overlapping length becomes small), thereby decreasing the ratio of the component of the electrostatic force in the vibration direction. However, facing surface 26a of each of projection portions 26f and 26s of movable electrode 24 and facing surface 27a of each of projection portions 27f and 27s of fixed electrodes 25f and 25s has an inclination of angle α in the X direction, with the result that when movable electrode 24 is moved toward fixed electrode 25f and 25s in the vibration direction, the distance d becomes small between the facing surface 26a of each of projection portions 26f and 26s of movable electrode 24 and the facing surface 27a of projection portions 27f and 27s of fixed electrodes 25f and 25s. Accordingly, the electrostatic force between movable electrode 24 and each of fixed electrodes 25f and 25s becomes large. Namely, the change in ratio of the component of the electrostatic force in the X direction as caused by movement of movable electrode 24 in the X direction is complemented by the change of the magnitude of the whole electrostatic force, thereby suppressing a change in electrostatic force between movable electrode 24 and each of fixed electrodes 25f and 25s in the X direction.

As such, in this vibration driving module, the change in driving force in response to displacement of movable electrode 24 is small because when projection portions 26f and 26s of movable electrode 24 come close to projection portions 27f and 27s of fixed electrodes 25f and 25s in the vibration direction, an electrostatic gap is decreased between facing surface 26a of each of projection portions 26f and 26s of movable electrode 24 and facing surface 27a of each of projection portions 27f and 27s of fixed electrodes 25f and 25s so as to suppress the electrostatic force generated between each of projection portions 26f and 26s of movable electrode 24 and each of projection portions 27f and 27s of fixed electrodes 25f and 25s from being changed in magnitude of the component in the vibration direction.

### Modification of Second Embodiment

The vibration driving module of the present invention is not limited to the second embodiment described above. In the above-described embodiment, the vibration driving module is configured to include three vibration driving units; however, the number and arrangement of vibration driving unit(s) can be changed appropriately, and one vibration driving unit may be provided. Moreover, in the second embodiment, each of the projection portions of the fixed electrodes is shifted to the vibration center C side relative to each of the projection portions of the movable electrode in the vibration direction, but may be shifted outwardly in the vibration direction. In this case, the relation between a fixed electrode fed with voltage and the direction of movement of the movable electrode becomes opposite to that in the above-described embodiment.

[Gyro Sensor]

Next, with reference to FIG. 9, the following describes an embodiment of a gyro sensor (MEMS sensor), which uses the vibration driving module of the second embodiment.

The gyro sensor of FIG. 9 includes: substrate 21 extending in the X-Y directions; two capacitance change detecting modules 210 formed side by side; and two pairs (four in total) of vibration driving modules 220 of the second embodiment, vibration driving modules 220 being provided on the both sides of each capacitance change detecting module 210 in the Y direction.

<Vibration Driving Module>

Since the configuration of vibration driving module 220 is the same as that of the vibration driving module of FIG. 4, no repeated description will be provided. Each pair of vibration driving modules 220 support a moving body 211, which is formed in the form of a quadrangular frame to surround capacitance change detecting module 210, and generate vibration in synchronism, thereby vibrating moving body 211 in the X direction.

<Capacitance Change Detecting Module>

Each of capacitance change detecting modules 210 is attached to moving body 211 by four driving springs 212 such that it is movable in the Y direction. Capacitance change detecting module 210 includes: a movable detection electrode 213 having a shape of three continuous frames integrally formed and arranged side by side in the Y direction; and fixed detection electrodes 214 fixedly formed on substrate 21.

In this gyro sensor, movable detection electrode 213 of capacitance change detecting module 210 is always reciprocatively moved in the X direction by vibration driving modules 220. In this state, Coriolis force acting on movable detection electrode 213 when the gyro sensor is rotated around the axis of the Z direction perpendicular to the X-Y plane is detected as a change of capacitance, caused by displacement of movable detection electrode 213 in the Y direction, between movable detection electrode 213 and fixed detection electrodes 214 and is converted into a change of direction of this gyro sensor.

Movable detection electrode 213 of capacitance change detecting module 210 is displaced in the Y direction by not only the Coriolis force resulting from the change of the direction of the gyro sensor but also inertia force resulting from a change of velocity of this gyro sensor in the Y direction. Hence, in this gyro sensor, a difference between displacements of movable detection electrodes 213 of two capacitance change detecting modules 210 is taken to cancel acceleration applied to this gyro sensor in the Y direction, thereby detecting only the Coriolis force generated by the rotation of this gyro sensor around the axis of the Z direction extending in the middle between two capacitance change detecting modules 210.

This gyro sensor can be produced by forming the components of vibration driving modules 220 and capacitance change detecting modules 210 on substrate 21 made of, for example, silicon by means of known semiconductor manufacturing technology such as photolithography, lamination of materials, etching, and the like.

<Advantage>

Since the gyro sensor includes vibration driving module 220, movable detection electrode 213 can be vibrated at a certain rate in the X direction. Accordingly, correlation is high between the Coriolis force acting on movable detection electrode 213 and angular velocity of substrate 21, thereby detecting the angular velocity with good precision.

Therefore, the MEMS sensor including the vibration driving module of the second embodiment is excellent in detection precision since the change in driving force of this vibration driving module is small.

### Modification of the Present Embodiment

The gyro sensor of the present invention is not limited to the above-described embodiment. In the above-described embodiment, the movable detection electrode is vibrated using two vibration driving units disposed to sandwich the movable detection electrode in the Y direction; however, the vibration driving modules may be disposed in any manner as long as the movable detection electrode is vibrated in the X direction. A fixed electrode may be formed to be divided between the projection portions.

Moreover, in the second embodiment described above, the facing surface of the projection portion of the movable electrode and the facing surface of the projection portion of the fixed electrode are inclined at the same angle relative to the vibration direction; however, they may be inclined at different angles or only one of them may be inclined relative to the vibration direction. A difference is preferably not more than 20° between the inclination angle of the facing surface of the projection portion of the movable electrode and the inclination angle of the facing surface of the projection portion of the fixed electrode.

Moreover, in the above-described gyro sensor, the structure of the capacitance change detecting module is not limited to the above-described embodiment. For example, as the capacitance change detecting module, there can be employed the same structure as that of vibration driving module 220 of the second embodiment. Namely, movable detection electrode 213 of the capacitance change detecting module may have the same shape as that of movable electrode 24 provided with the plurality of projection portions. Moreover, fixed detection electrode 214 of the capacitance change detecting module may have the same shape as that of each of first and second fixed electrodes 25f and 25s each including the plurality of projection portions. In this case, the plurality of projection portions of the fixed detection electrode and the projection portions of the movable detection electrode are provided to face each other; however, a positional relation there between is the same as the positional relation between each of projection portions 27f and 27s and each of the projection portions 26f and 26s in vibration driving module 220.

Also when the capacitance change detecting module is thus structured, Coriolis forces acting on the movable detection electrodes of the two capacitance change detecting modules when the gyro sensor is rotated about the axis of the Z direction perpendicular to the X-Y plane are detected as a change of capacitance, caused by displacements of the movable detection electrodes in the Y direction, between the movable detection electrode and the fixed detection electrode, and can be converted into the change of direction of this gyro sensor as with the case described above.

### Example 2

The following describes the vibration driving module of the second embodiment of the present invention more in detail by way of an Example 2; however, the present invention is not limited to Example 2.

For Example 2 of the vibration driving module of the second embodiment configured as described above, electrostatic force acting between the movable electrode and each of the fixed electrodes in the vibration direction was analyzed by simulation using a computer.

In the model used in the simulation, each of the projection portions of the movable electrode has a protrusion height of 5 μm in the Y direction and has a length of 5 μm in the X direction (vibration direction), and an interval between adjacent projection portions of the movable electrode in the X direction is 5 μm. On the other hand, each of the projection portions of the fixed electrode has a protrusion height of 4 μm in the Y direction and has a length of 5 μm in the X direction, and an interval between adjacent projection portions of the fixed electrode in the X direction in the arrangement is 5 μm. The overlapping length of the projection portion of the movable electrode and the projection portion of the fixed electrode in the vibration direction at the vibration center is 2.5 μm. The distance between the center of the facing surface of the projection portion of the movable electrode and the center of the facing surface of the projection portion of the fixed electrode in the Y direction when the movable electrode is located at the vibration center is 1.5 μm. The inclination angle of the facing surface of the projection portion of the movable electrode relative to the X direction has the same value as the inclination angle of the facing surface of the projection portion of the fixed electrode relative to the X direction. Then, a plurality of models were prepared by employing the same conditions as above and employing different inclination angles of the facing surface of the projection portion of the movable electrode and the facing surface of the projection portion of the fixed electrode relative to the X direction.

(Result of Simulation)

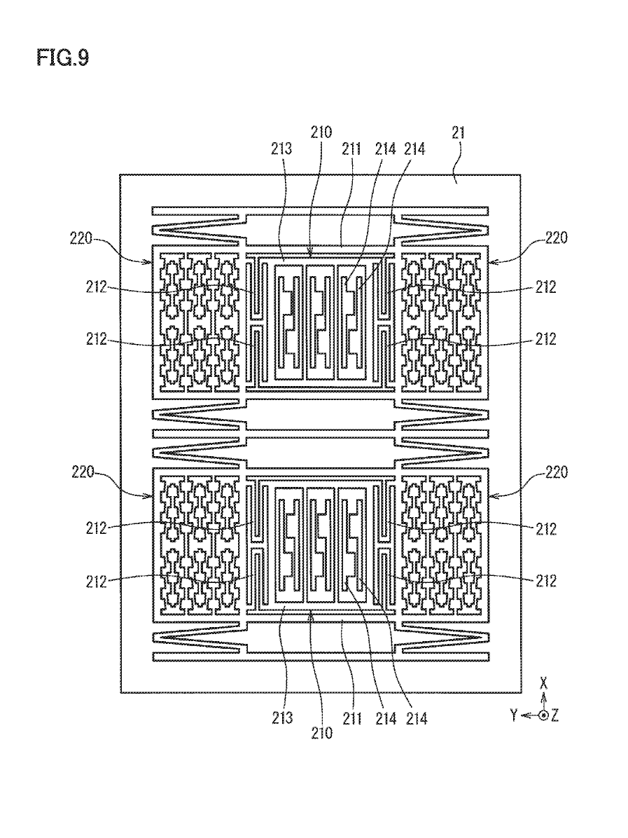

For each of the plurality of models, as a result of simulating the value of the electrostatic force acting between the movable electrode and the fixed electrode in the vibration direction when the movable electrode is displaced from the vibration center in the X direction, it was found that a relation between the displacement of the movable electrode and the electrostatic force in the vibration direction is changed depending on the inclination angle of the facing surface of the projection portion in the X direction as shown in FIG. 8.

Table 1 shows a rate of change of electrostatic force per amount of displacement of the movable electrode (inclination of each graph of FIG. 8) as obtained by the simulation.

TABLE 1

| Inclination Angle | Inclination |
|---|---|
| (Degree) | (nN/μm) |
| 0 | −1.83 |
| 1 | −0.23 |
| 2 | 0.08 |
| 3 | 0.35 |
| 6 | 1.05 |
| 7 | 1.23 |
| 8 | 1.40 |

From this result, it was confirmed that by appropriately selecting the inclination angle of each of the facing surface of the projection portion of the movable electrode and the facing surface of the projection portion of the fixed electrode relative to the X direction, the electrostatic force acting between the movable electrode and the fixed electrode in the vibration direction can always be kept constant even when the movable electrode is displaced.

### INDUSTRIAL APPLICABILITY

As described above, the vibration driving module of the present invention provides large driving force and amplitude. Moreover, the vibration driving module of the present invention allows for a small change in driving force. Hence, a MEMS sensor employing this vibration driving module is highly precise and can be suitably for a mobile terminal or the like as a gyro sensor.

### REFERENCE SIGNS LIST

1: substrate
2: vibration driving unit
3: elastic body
4: movable electrode
5f and 5s: fixed electrode
6f and 6s, 6a: projection portion
7f and 7s, 7a: projection portion
8: fixed wall
10: capacitance change detecting module
11: moving body
12: driving spring
13: movable detection electrode
14: fixed detection electrode
20: vibration driving module
C: vibration center
P: center axis
21: substrate
22: vibration driving unit
23: elastic body
24: movable electrode
25f and 25s: fixed electrode
26f and 26s: projection portion
26a: facing surface
27f and 27s: projection portion
27a: facing surface
28: fixed wall
210: capacitance change detecting module
211: moving body
212: driving spring
213: movable detection electrode
214: fixed detection electrode
220: vibration driving module

1. A MEMS sensor module, comprising:
a movable electrode which translates back and forth along an axis of movement;
first and second stationary electrodes facing first and second portions of the movable electrode, respectively;
a plurality of first projections extending from the movable electrode toward the first stationary electrode;
a plurality of second projections extending from the movable electrode toward the second stationary electrode;
a plurality of third projections extending from the first stationary electrode toward the first portion of the movable electrode such that each of the third projections partially overlaps a respective one of the second projections; and
a plurality of fourth projections extending from the second stationary electrode toward the second portion of the movable electrode such that each of the fourth projections partially overlaps a respective one of the second projections;
the first and third plurality of projections, on the one hand, and the second and fourth plurality of projections, on the other, partially overlapping one another in opposite directions.

2. The MEMS sensor module of claim 1, wherein the first and second portions of the movable electrode lie along the axis of movement.

3. The MEMS sensor module of claim 1, wherein the movable electrode is caused to vibrate back and forth along the axis of movement when voltages are alternatively applied to and removed from the first and second stationary electrodes.

4. The MEMS sensor module of claim 1, wherein:
the first stationary electrode has first and second opposite sides, the third projections extending from the first side, a plurality of fifth projections extending from the second side in the opposite direction of the first projections; and
the movable electrode has a third portion which faces the second side of the first stationary electrode and a plurality of sixth projections extending from the third portion toward the second side of the first stationary electrode such that each of the sixth projections partially overlaps a respective one of the fifth projections.

5. The MEMS sensor module of claim 4, wherein the direction of the partial overlap of the fifth and sixth projections is the same as the direction of partial overlap of the first and third projections.

6. The MEMS sensor module of claim 1, wherein:
the second stationary electrode has first and second opposite sides, the fourth projections extending from the first side of the second stationary electrode, a plurality of seventh projections extending from the second side of the second stationary electrode in the opposite direction of the first projections; and
the movable electrode has a fourth portion which faces the second side of the second stationary electrode and a plurality of eighth projections extending from the second side toward the second surface of the stationary electrode such that each of the eighth projections partially overlap a respective one of the seventh projections.

7. The MEMS sensor module of claim 6, wherein the direction of the partial overlap of the seventh and eighth projections is the same as the direction of partial overlap of the second and fourth projections.

8. The MEMS sensor module of claim 1, wherein an average overlapping length of the first and second projections of the movable electrode and the third and fourth projections of the first and second stationary electrodes, respectively, along the axis of movement is not less than 1 μm and not more than 10 μm.

9. The MEMS sensor module of claim 1, wherein an average non-overlapping length of the first and second projections of the movable electrode and the third and fourth projections of the first and second stationary electrodes, respectively, along the axis of movement is not less than 1 μm and not more than 10 μm.

10. The MEMS sensor module of claim 1, wherein an average length of the first and second projections of the movable electrode and the third and fourth projections of the first and second stationary electrodes, respectively, along the axis of movement is not less than 1 μm and not more than 20 μm.

11. The MEMS sensor module of claim 1, wherein a facing surface of each of the first and second projections of the movable electrode and the third and fourth projections of the first and second stationary electrodes, respectively, is inclined relative to axis of movement.

12. The MEMS sensor module of claim 11, wherein the inclination of each of the facing surfaces of the first to fourth projections relative to the axis of movement is not less than 0.1° and not more than 15°.

13. The MEMS sensor module of claim 1, wherein a facing surface of each of the first and second projections and a facing surface of each of the third and fourth projections are parallel to one another.

14. The MEMS sensor module of claim 1, wherein each of the projections has a first edge facing a first direction relative to the axis of movement and a second edge facing a second, opposite, direction relative to the axis of movement, the first edge of each of the first electrodes overlapping the second edge of a respective one of the third electrodes, the second edge of each of the second projections overlapping the first edge of a respective one of the fourth projections.

15. A MEMS sensor comprising a MEMS sensor module including:
a movable electrode which translates back and forth along an axis of movement;
first and second stationary electrodes facing first and second portions of the movable electrode, respectively;
a plurality of first projections extending from the movable electrode toward the first stationary electrode;
a plurality of second projections extending from the movable electrode toward the second stationary electrode;
a plurality of third projections extending from the first stationary electrode toward the first portion of the movable electrode such that each of the third projections partially overlaps a respective one of the second projections; and
a plurality of fourth projections extending from the second stationary electrode toward the second portion of the movable electrode such that each of the fourth projections partially overlaps a respective one of the second projections;
the first and third plurality of projections, on the one hand, and the second and fourth plurality of projections, on the other, partially overlapping one another in opposite directions.

16. The MEMS sensor of claim 15, further comprising a capacitive change detecting module.

17. The MEMS sensor of claim 16, wherein the capacitive change sensing module includes a plurality of opposing electrodes, the spacing of each pair of opposing electrodes of the capacitive change sensing module varying as a function of Coriolis forces applied to the MEMS sensor.

18. The MEMS sensor of claim 17, wherein the opposing electrodes of the capacitive change sensing module extend in a direction perpendicular to the axis of movement.
